(19) United States
(12) Patent Application Publication
(10) Pub. No.: US 2006/0285152 A1
(43) Pub. Date: Dec. 21, 2006

(54) METHOD AND SYSTEM FOR EMBEDDING NATIVE SHAPE FILE AND MAPPING DATA WITHIN A PORTABLE DOCUMENT FORMAT FILE

(76) Inventor: William Andrew Skillen, Atlanta, GA (US)

Correspondence Address: E.J. Asbury III, Esq.;Taylor, Busch, Slipakoff & Duma, LLP, Suite 200, 1600 Parkwood Circle, Atlanta, GA, 30339, US

(21) Appl. No.: 11/424,721

(22) Filed: Jun. 16, 2006

Related U.S. Application Data
(60) Provisional application No. 60/691,741, filed on Jun. 17, 2005.

(51) Int. Cl. G06F 3/12

(52) U.S. Cl. 358/1.15; 358/3.28

(57) ABSTRACT

This invention relates to a system and method for embedding and maintaining native shape file and cartographic, or mapping data from a Geographic Information System within a portable document format file. Once this data has been embedded, it can be viewed and worked with using PDF applications such as Adobe Acrobat or Adobe Reader. The invention also discloses a system and methodology for the export of embedded native shape file format coordinates, layers and data objects from within the Portable Document Format (PDF) along with any associated vector red-lines, markups, text edits and database edits made directly to the embedded shape file objects for export back into GIS applications and other applications. The invention utilizes the PDF file format as a true GIS data exchange medium.

### CROSS-REFERENCE TO RELATED APPLICATION

This application claims the benefit of U.S. Provisional Application Ser. No. 60/691,741 filed on Jun. 17, 2005, which is herby incorporated herein by reference.

### BACKGROUND OF THE INVENTION

1. Field of the Invention

The present invention generally relates to cartography and the publishing and usage of maps. More particularly, the invention relates to a method and system for embedding and maintaining native shape file and mapping data within a portable document format file (PDF).

2. Description of the Related Art

Geographic Information Systems (GIS) are software applications used for the creation and analysis of maps and spatial data. They allow users to create and edit maps, and associate objects in the maps with database information. Maps within a GIS application are also referred to as digital source maps. The primary means for associating database information with a particular geographic location on the map is via a coordinate system. If you click on an object in an electronic map, a building for example, you can view the database information associated with that particular building for example: lat-long, address, tenants, emergency contact info, buried piping end electrical, ets. GIS applications also allow for layering mapping information, so that the user can click on different layers to see the same map location with different types of objects displayed. For example, for a given city block you could just display the layers showing ‘restaurants’ and ‘hotels’ to see which hotel is closest to the most number of restaurants. Or someone else may display the layer for underground phone lines if they needed to dig a trench. These are primary examples of how GIS software offers additional benefits that paper maps can't provide.

Various companies offer GIS software, including ESRI, Bentley and Intergraph. These companies offer GIS and GPS applications that also allow for map viewing and for associating database information with geo-referenced maps. The primary vendor of GIS software in the US market is Environmental Systems Research Institute, Inc. or ESRI. ESRI offers a GIS software application known as ArcGIS. Roughly two-thirds of GIS professionals currently use ArcGIS for map creation and analysis. One of the key ways that GIS applications, such as AcrGIS, share mapping data is via the distribution of digital shape files. Digital shape files, or more simply shape files, can be imported and exported by many GIS and GPS applications. Many of these applications also allow for export to PDF files. However, currently only the PDF map image is exported when saving to PDF. The coordinate data, attribute data and database information is lost when exporting to PDF.

The Portable Document Format (“PDF”) file format can be thought of as a very well structured container that allows for putting a PDF “wrapper” around many types of data objects. Thus, external file types and data types can be embedded with the PDF file and accessed by PDF Writer/Reader applications. The PDF file format is an open file format specification, with the technical description for creating and writing PDF files fully available to the general public. Adobe Systems Inc, has written the PDF file format, and Adobe Acrobat is the most common PDF writer application, but there are other applications on the market that also allow for creation of PDF files. The PDF file format is one common form of electronic graphic file, other common forms are a portable document format file, a tagged image file format (TIF) file, geo-tiff (GeoTIFF), a scalable vector graphics (SVG) file, a Bentley Digital InterPlot (DPR) file, and an extensible markup language (XML) file, as well as other forms as are known to those skilled in the art.

A PDF specification is published by Adobe for use by developers of PDF applications. The original PDF specification was first published in 1993. The current PDF 1.6 Specification is the 5th revision of this document and was introduced in 2004. The current PDF 1.6 Specification may be obtained from Adobe Publishing online at: http://partners.adobe.com/public/developer/pdf/ and is incorporated herein by reference. The open file format specification of the Portable Document Format has helped to make PDF the de facto standard for document publishing and electronic document exchange. The PDF 1.6 specification contains detailed information for the creation of all types of PDF files.

The Shape file format is an open file format specification with the technical description for creating and writing shape files fully available to the general public. ESRI has published the shape file format technical description, but there are other applications that also allow for creation of shape files. The ESRI Shapefile Technical Description was published by Environmental Systems Research Institute, Inc., Copyright 1997, 1998, and is incorporated herein by reference. Shape files are a common way of importing and exporting mapping information from a variety of GIS and GPS applications. As known to those skilled in the art, the term “shape file” is also commonly referred to as “shapefile” or “shape”.

Since 1982, the PDF file specification has become a standard for publishing data to the general public in industry after industry. Until recently, the PDF file format could not handle large size documents, nor the complexity associated with today's GIS mapping systems and data. With the improvements made to the PDF file format specification in version 1.6, the open PDF file specification now has the power to replicate typical GIS viewing capabilities associated with Geographical Information Systems.

Because GIS systems are so difficult to use, there has been some difficulty in providing GIS information to the general public. There are mapping applications such as MapQuest which have found success with the general public, but these maps are simple raster images that do not include vector or attribute data about objects in the map. MapQuest is a simplified internet based method for viewing maps. On the PDF side, there has been the publishing of image PDF maps, commonly exported from within GIS applications as a print view, but these PDF maps in raster or vector format exclude coordinate, database and attribute information. Both of these approaches have fallen short of delivering the full mapping functionality offered by GIS viewers, which allow for viewing layers, coordinates and attributes for objects in a map. Currently, there is a need in the art for an invention which allows for embedding all the valuable digital information contained within a GIS map inside the PDF map as well.

### SUMMARY OF THE INVENTION

The disadvantages of the prior art are overcome by the present invention which, in one aspect, is a method for embedding geographic information from a digital source map into an electronic graphics file, and embedding the native coordinate data in the digital source map into the electronic graphics file. The method including the steps of receiving an electronic graphics file representing a digital source map. Receiving geographic information associated with the digital source map, the geographic information including a digital shape file. Embedding the digital shape file within the electronic graphics file, the digital shape file including native coordinate data, the native coordinate data specifying a position in the digital shape file. And wherein the position of the native coordinate data in the digital shape file is associated with a geographic position within the electronic graphics file.

The method for embedding geographic information from a digital source map where the digital shape file further includes a page object on a layer in the electronic graphics file. The digital shape file may include at least one transparent shape file. The digital shape file may include a native coordinate data array embedded within the electronic graphics file, and may also include a bounding box, the bounding box representing a map border within the digital shape file.

The method for embedding geographic information from a digital source map where the digital shape file further includes receiving a geographic position selection within the electronic graphics file. Retrieving the native coordinate data of the digital shape file associated with the selected geographic position. And displaying the native coordinate data within the electronic graphics file interface.

The method for embedding geographic information from a digital source map into an electronic graphics file, and embedding the native coordinate data in the digital source map into the electronic graphics file further includes embedding a plurality of digital shape files within the electronic graphics file, and wherein a geographic position within the electronic graphics file is associated with a plurality of native coordinate data from the plurality of digital shape files. The plurality of digital shape files can be embedded as a transparency stack in the electronic graphics file. The plurality of digital shape files may be embedded in the electronic graphics file in the same stacking order as the digital shape files were stacked in the digital source map.

The method for embedding geographic information from a digital source map into an electronic graphics file, and embedding the native coordinate data in the digital source map into the electronic graphics file wherein receiving geographic information associated with a digital source map further includes receiving a user selection of source map data from a digital source map. The embedded geographical information is geo-registered. The coordinate data of the digital shape file includes a character data string and a coordinate data position, and the character data string is rendered at a geographic position within the electronic graphics file associated with the coordinate data position in the digital shape file. The electronic graphics file includes at least one of the following: an Adobe Acrobat® portable document file, a portable document format file, a tagged image file format (TIF) file, geo-tiff (GeoTIFF), a scalable vector graphics (SVG) file, a Bentley Digital InterPlot (DPR) file, and an extensible markup language (XML) file. The electronic graphics file includes at least one of the following: a file format viewable by a viewer, a file format viewable by a file reader application program, and a file format viewable by an application program for the display of graphics files. The coordinate data includes at least one of the following: a longitude, a latitude, an elevation, a terrain feature, a set of geographic coordinates, a geographic feature, a character data string, weigh points and tracks, a road, a body of water, a mountain, a place, a land mass, and geographic information. The digital source map includes at least one of the following: a digital map, a GIS landbase, a GPS output, a CAD drawing, a raster-based image, a database, a data storage device, a memory, and a digital map stored in a data storage device.

In another embodiment, the invention includes a method for viewing embedded native geographic information within an electronic graphics file. The method includes receiving an electronic graphics file with geographic information, the electronic graphics file including embedded native geographic information from a digital source map, wherein the embedded native geographic information is geo-registered, and the native geographic information including at least one digital shape file, the digital shape file including native coordinate data, the native coordinate data having a position in the digital shape file. The method further including accessing the electronic graphics file with an application program adapted to display the electronic graphics file, including selecting a geographic position within the electronic graphics file wherein the native coordinate data in the digital shape file, associated with the geographic position within the electronic graphics file, is displayed.

The method for viewing embedded native geographic information within an electronic graphics file may further include receiving an electronic graphics file with geographic information includes receiving a user selection of source map data from a digital source map. The digital shape file includes at least one vector red-line; and the vector red-line is displayed within the electronic graphics file.

In another embodiment, the invention includes a method for embedding red-line vectors into an electronic graphics file, and associating the geographic position of the red-line vector in the electronic graphics file with a position in the native geographic information, the method including the steps of receiving an electronic graphics file representing a digital source map, receiving native geographic information associated with the digital source map, receiving a red-line vector in the electronic graphics file, the red-line vector having a geographic position in the electronic graphics file, and embedding the red-line vector into the native geographic information, the embedded vector red-line having a position in the native geographic information associated with the geographic position in the electronic graphics file. The red-line vector may include at least one of the following: text, graphics, points, polylines, polygons, and spheres. The native geographic information may include a comments layer embedded within the electronic graphics file, and embedding the red-line vector into the native geographic information includes embedding the red-line vector into the comments layer. The native geographic information may include a digital shape file embedded within the electronic graphics file; and embedding the red-line vector into the native geographic information includes embedding the red-line vector in the digital shape file. The method may include a method of exporting the red-line vectors from the electronic graphics file and into a digital source map, the method including, exporting a digital shape file from the electronic graphics file, the digital shape file included of a vector red-line, the vector maintaining a position in the digital shape file, and importing the digital shape file, with the embedded vector red-line, into a digital source map, and wherein the position of the vector red-line in the digital source map is associated with a geographic position within the electronic graphics file.

In another embodiment, the invention includes a method for embedding native geographic information from a digital source map into an electronic graphics file, and rendering character data from the digital source map at an associated geographic position in the electronic graphics file, the method including the steps of receiving an electronic graphics file representing a digital source map, receiving native geographic information associated with the digital source map, the geographic information including a digital shape file, embedding the digital shape file within the electronic graphics file, the embedded digital shape file including at least one native character data string, the native character data string having a position in the digital shape file, and wherein the character data string is rendered at an associated geographic position within the electronic graphics file.

In another embodiment, the invention includes a method for embedding geographic information from a digital source map into an electronic graphics file, and rendering native digital shape file dBASE information from the digital source map at an associated geographic position in the electronic graphics file, the method including the steps of receiving an electronic graphics file representing a digital source map, receiving geographic information associated with the digital source map, the geographic information including a digital shape file, embedding the digital shape file within the electronic graphics file, the embedded digital shape file including native digital shape file dBASE information, the native digital shape file dBASE information having a position in the digital shape file, and wherein the native digital shape file dBASE information having a position in the digital shape file is rendered at an associated geographic position within the electronic graphics file.

### BRIEF DESCRIPTION OF THE DRAWINGS

FIG. 1 depicts the a brief summary of the methodology of embedding the GIS data within a Portable Document Format file.

FIG. 2 depicts the hypothetical creation of a PDF file representing a map with two polygon features.

FIG. 3 depicts how the internal structure of a Shape object contains adequate data for the generation of a shapefile entry.

FIG. 4 depicts how the GISSchema definition of a layer can fully define tabular attributes and geometry.

FIG. 5 depicts how the marked content representing the map boundary is linked to a Viewport object via a parent tree.

### DETAILED DESCRIPTION OF THE INVENTION

This invention relates to a system and method for embedding and maintaining native shape file and cartographic (mapping) data from a Geographic Information System (“GIS”) within a portable document format file. As defined herein, “Native” refers to raw GIS source data without the need for massaging, translating or transforming the data. The source data persists in the PDF file as it existed in the GIS file. Native simply refers to the source GIS data as it existed in the particular GIS file. Once this GIS native data has been embedded in the PDF file, it can be viewed and worked with using the Adobe Acrobat or Adobe Reader applications, or other PDF applications as are known to those skilled in the art. A system and methodology for the embedding and display of native shape file coordinates, layers and data objects (shape file vectors; shape file dBASE data and other cartographic information from within the source GIS file) for display within the Portable Document Format (PDF). The system also describes a system and methodology for the export of embedded native shape file format coordinates, layers and data objects from within the Portable Document Format (PDF) along with any associated vector red-lines, markups, text edits and database edits made directly to the embedded shape file objects for export back into GIS applications and other applications. Methods for how API's will interact with the embedded shape file data within PDF files will also be described.

Although various references will be made to the Adobe Acrobat and Adobe Reader application herein, as may be appreciated by one skilled in the art, any PDF Reader/Writer application can make full use of the invention. Currently, Adobe PDF viewing technology is already on over 700,000,000 computers, making this invention most viable for that large segment of the market. However, this invention will also allow users of PDF viewing applications such as the Jaws PDF writer/viewer to also benefit from this invention. Additionally, with the introduction of Adobe Reader 7.0, and the ability for anybody with the free Adobe Reader to place red-lines and markups upon PDF maps, PDF viewing applications now move a step ahead of GIS viewing applications in what they allow the end-user to do for free (e.g. View, red-line, markup and save the PDF map locally). In the future, PDF files will only continue to become a more viable method for distributing complex GIS data.

The problem with most GIS viewers is that few people have them, or know how to use GIS viewers. With the publishing of the latest open PDF specification, the PDF file format is now a viable way to distribute mapping data to the general public retaining the ability to do most of the same GIS viewing functions found in GIS viewers. Since Adobe Reader already exists on most computers and people are familiar with the Adobe Reader application, PDF is an ideal way to allow publishing of GIS data to the general public. The use of plug-ins created for Adobe Acrobat or Adobe Reader also allow for further interaction with the embedded GIS data.

By allowing for the embedding, viewing, editing and export of native shape file and associated cartographic data within the PDF file format specification, an exciting new set of GIS viewing, editing and exporting capabilities can be exploited within PDF viewing applications. Because both of these file formats are open standards, they are the ideal file formats for publishing mapping data to the general public and for usage by government. Publishing GIS information to PDF is an ideal way to allow First Responders, military and other end-users the ability to easily access critical mapping data using nothing more than Adobe Reader or similar PDF viewing tool.

The embedding of native shape file data within a PDF file solves some specific problems. Currently, GIS applications allow for exporting a PDF file from within the application. These PDF files are “dumb” images of the map exported from within the GIS and lack important characteristics associated with the native GIS file format. Specifically, the shape file coordinate system associated with a shape file (or other GIS file types) does not carry over into the PDF file. Additionally, attribute information or database information about objects in the map is also lost. By allowing for the export of both the PDF image map, and the embedding of associated shape file data, such as shape file coordinates and shape file database information, for the exact same coverage area as the PDF image, end-users of this enhanced “PDF+Shape” get access to native GIS information within PDF viewing applications. The GIS or digital source map may include a digital map, a GIS landbase, a GPS output, a CAD drawing, a raster-based image, a database, a data storage device, a memory, and a digital map stored in a data storage device.

The invention described herein utilizes the PDF file format as a GIS data exchange medium. In a first embodiment, the invention deploys an extension to the GIS application Arcmap that exports the PDF layout in a custom format. The organization of the data is much more structured than in the prior art in how this invention associates mapbounds and map objects. In another embodiment of the invention, the methodology associates the GISschema with each layer, and the GIS shapefile metadata for each feature. This invention exports all the necessary native shapefile and source data and cartographic information to allow for completely describing the source data represented in the original ArcMap application, and to allow for re-creating the source file by exporting it back out of the PDF file.

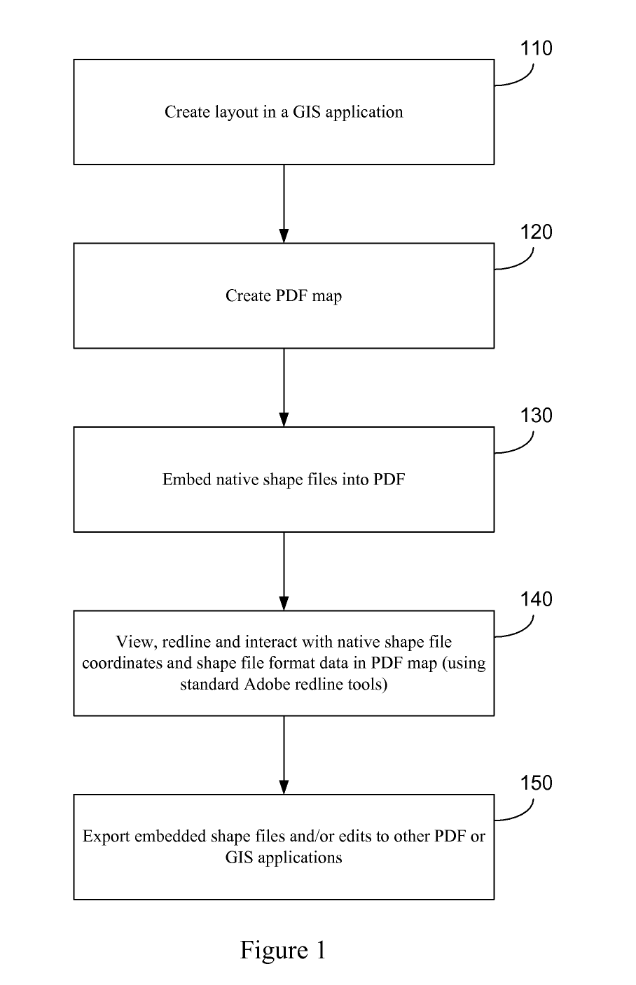

FIG. 1 depicts a brief summary of the methodology of a first embodiment of the invention. As depicted in FIG. 1, at 110, the starting point a layout in a GIS application, such as ESRI's ArcMap, that contains one or more viewports or dataframes. This description will include references to ERSI's ArcMap application to demonstrate the methodology, however as will be appreciated by those skilled in the art, other GIS applications may be used as the source of the viewports, dataframes, and shapefiles. Most current GIS application are capable of outputting a PDF file shown at 120. The viewports or dataframes in ESRI ArcMap correspond to what this invention defines as a mapobjects in the PDF file 120.

The invention uses an extension to source GIS application, in this example ArcMap, that outputs mapobjects, at 130, into the PDF format created at 120. The invention allows for one or more dataframes to correspond to mapobjects. The ArcMap dataframe can consist of one or more feature layers. The ArcMap feature layers will correspond to layer objects in the PDF file format. Data layers can also come from other GIS applications such as ESRI SDE, or other geo-database or shapefiles. Each dataframe, or record, has a set of tabular attributes which correspond to the database, or dBASE file, in the ESRI shapefile, or other GIS application shapefile. This invention associates all the additional data with each map and with each graphic that is represented in GIS system so that no source mapping data is lost when creating the PDF map. As will be appreciated by one skilled in the art, the step of creating the PDF file at 120, and the step of outputting mapobjects into the PDF file at 130, may occur simultaneously, or mapobjects may be loaded into preexisting PDF representing the geographic area of the GIS map.

As further depicted in FIG. 1, at 140, the user may red-line and markup the PDF, using the existing functionality within common PDF tools such as Adobe Acrobat. Since the drawing tools in Acrobat are vector based, the red-lines or markups may be embedded within the PDF layers representing the shapefile. As a final step, at depicted at 150, the user may export any red-line edits to the shapefile data back out to both PDF users and GIS viewers as part of a collaborative workflow process that includes users of PDF viewing and writing systems, as well as GIS/GPS viewing and writing systems. The red-line edits may include: text, graphics, points, polylines, polygons, and spheres.

The shape file data types, coordinates and layers become available for viewing in the PDF map via an Application Programming Interface (API) to Adobe Reader, Adobe Acrobat and/or other PDF reader/writers. This will allow end-users to view shape file coordinates, view any imported shape file vector objects, and view dBASE information about objects in the PDF map. Within Adobe Acrobat, a user can click on the shape file object or layer stored within the PDF file and for any shape file coordinate selected, an API within Adobe Acrobat or Adobe Reader (or other PDF readers) will display the native shape file coordinate (lat-long, northing easting; in whatever datum/projection was originally set by the GIS user when exporting the shape file). In this methodology, there is no transformation or translation or conversion between the original shape file coordinate system and what is displayed. The coordinate data may include a longitude, a latitude, an elevation, a terrain feature, a set of geographic coordinates, a geographic feature, a character data string, weigh points and tracks, a road, a body of water, a mountain, a place, a land mass, and other geographic information. All of the above geographic information is geo-referenced by the coordinate data and associated coordinate system.

One skilled in the art of shape file format data structure and the PDF data structure can take the methodologies described herein to embed native shape file coordinates within PDF file structure. One skilled in the art and familiar with Adobe PDF libraries and the creation of API's for manipulating PDF files can write API's for displaying and interacting with native shape file data embedded in PDF files.

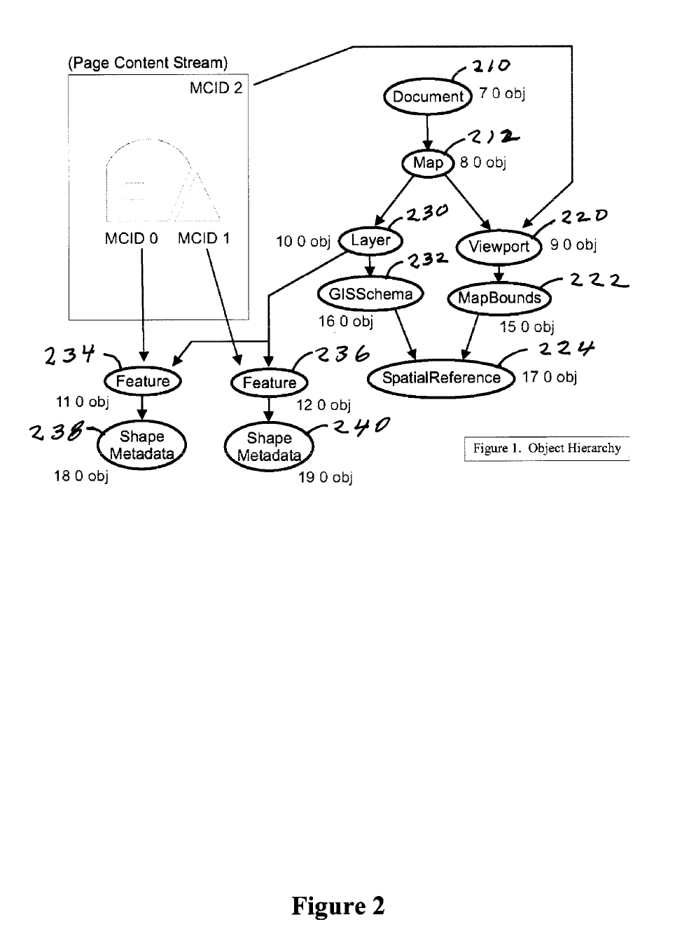

FIG. 2 depicts a layout in a common GIS application being encapsulated within a PDF file structure. In FIG. 2, ovals represent objects in the PDF file, while subscripts represent the object IDs. Marked content IDs (“MCID”) are shown, and arrows indicate relationships to structural element objects. Marked content refers and relates to how each piece of GIS data, is marked and tracked. A Document object 210 may have one or more Map objects 212 as children. Each Map 212 has one Viewport object 220 and one or more Layer objects 230 as children. A Viewport object 220 includes a MapBounds definition 222, which in turn has a SpatialReference definition 224. A Layer 230 has a GISSchema definition 232, which defines tabular attributes and the geometry (shape) field, which also has a SpatialReference definition 224. Each Layer 230 has one or more Feature objects 234, 236 as children. Each feature object 234, 236 contains tabular attributes in the form of user properties, and has a real world geometry (hereinafter referred to as Shape) descriptor in the form of an XMP metadata stream 238.

Each content element representing a map feature is marked and linked to a Feature object 234, 236. Each content element representing a map boundary is marked and linked to a Viewport object 220. Because objects exist within the PDF describing not only attribute values but also real world geometry and feature layer schema, this allows the file to act as a complete and open GIS data exchange medium. Features encapsulated in the file may be queried, examined, and exported into another GIS format such as shape files. In addition, the Viewport 220 MapBounds definition 222 allows setting up a tool to display coordinates and measurements.

Between the document 210 and layer 230 a map 212 is created for each mapframe. Each layer 230 is linked to the map 212 resulting in a logical navigation system so that a plug-in to a PDF reader, such as Adobe Acrobat or Adobe Reader, can navigate through these invented file structures. The invention includes the GISschema 232 for the feature layer 230 which is a complete description of geometry type and field type for each map layer 230 and for each graphic (see FIG. 1 MCID 0 and 1) and each are mapped to a feature record 234, 236 which contains attributes but also embeds shapefile metadata 238, 240. By embedding the shape file metadata 238, 240 we are embedding the whole shape file along with all the associated GIS mapping data so that we have effectively re-created the original datasource including native shape files, shape file coordinates, layers, vectors, dBASE data and other related cartographic and GIS data within the PDF file. The marked content ID's allow for navigating through the GIS data within a PDF file structure.

The invention embeds all of the necessary native source data that appears in the original GIS application, for example the application ArcMap, into the PDF file and thus allows for viewing, redlining and exporting this native data back out to other GIS systems. Since the geometry is XML-based and the invention uses the native PDF dictionary in the PDF file format specification to store this data in the PDF file, there is no need for an Acrobat plug-in in order to view the native data that has been embedded with the PDF file. An Adobe Acrobat or Adobe Reader plug-in allows the display and re-projection of coordinates and attributes and dbase information, and allows for the export of shape file and other cartographic and GIS data back out of the particular PDF application to other GIS systems. The invention uses XML as the mechanism for embedding the geometry specifically because this mechanism is compliant with the PDF specification. By associating the GISschema 232 with each layer 230 and the GIS shapefile metadata 238, 240 for each feature 234, 236 we have exported all the necessary source data and source mapping information into the PDF file to allow for completely describing the source data that was represented in the original GIS application ArcMap.

The invention embeds the original geometry descriptor into the PDF so that the PDF file is literally carrying within it all source data and database information. The invention does not just embed user properties, for example the name of a park, but rather it also embeds additional information using the GISschema, so that the description of the feature layer itself is described such as data types, internal/external names of fields, geometry types, spatial index grid sizes, all of which is the same kind of information you would be able to view if you exported an XMLschema from the GIS application ArcCatalog. Likewise, the internal structure defined herein thus allows for re-creating all data into another database. In summary, this invention utilizes the PDF file format as a true GIS data exchange medium. Because the PDF file format does not natively allow for working with and displaying double-precision numbers, this invention displays double-precision numbers (coordinates) as strings.

One skilled in the art of shape file format data structure and the PDF data structure can take the methodology described herein to embed native shape file coordinates within PDF file structure. One skilled in the art and familiar with Adobe PDF libraries and the creation of API's for manipulating PDF files can write API's for displaying and interacting with native shape file data embedded in PDF files. This methodology describes a process for display of the original shape file coordinates to be maintained and displayed within the PDF file. Similarly, if multiple shape file layers or objects are stored with multiple shape file coordinate systems as different layers or objects in the PDF file, an Adobe Acrobat API can display the multiple shape file coordinate displays associated with that location in the map.

The internal structure of the Shape object contains adequate data for the generation of a shapefile entry. Map geometry, depending on the data source, is not necessarily a simple list of vertices. A complete geometry descriptor may include parametric curves, such as circular arcs, elliptical arcs, and cubic bezier curves. Ideally, it should be able to handle other geometry types such as annotations and dimensions. Typically, when such geometry is exported to another format (such as a shapefile), curves are converted to line segments which approximate its shape. That need not be the case, however, with the data stored within the PDF.

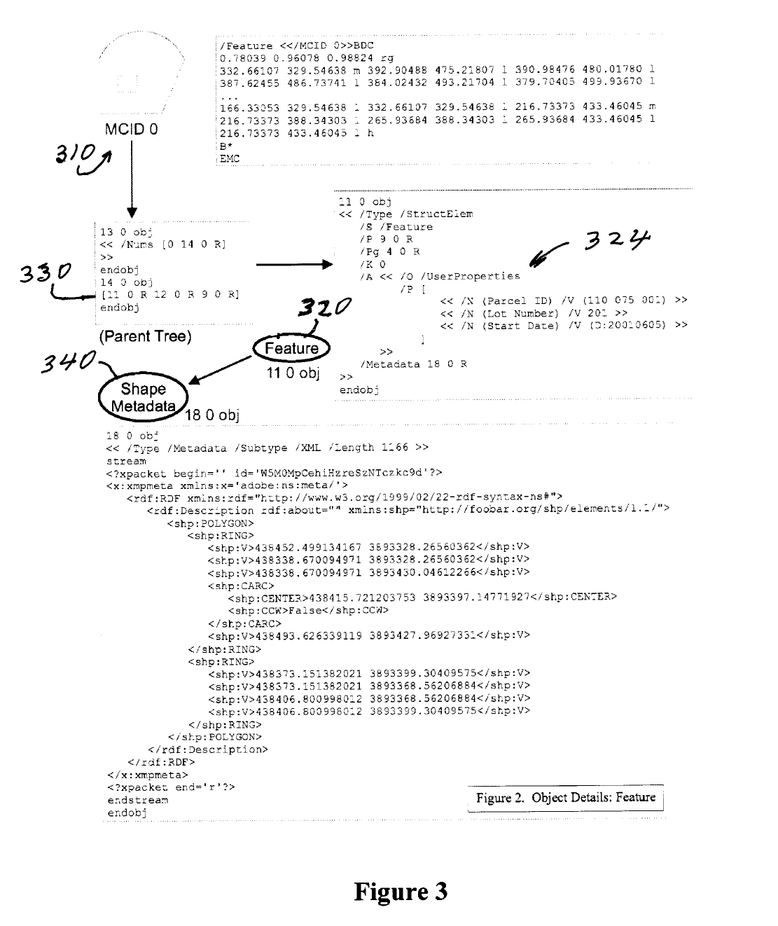

As depicted in FIG. 3, marked content 310 is linked to a feature structural element 320 via a parent tree 330. The Feature 320 contains user properties 324 representing feature attributes (Parcel ID, Lot Number, and Start Date). In addition, the Feature 320 has a Metadata entry 340 which refers to a Shape record. This stream is a descriptor in XML of the original real world geometry. This allows the marked content 310 to be linked to real world geometry, and yet be independent of its content. Note, for example, that the GIS application ArcMap in PDF output approximates curves with line segments, while the XML descriptor contains the original curve definition.

The Feature object 320 contains a descriptor of the map feature represented by the related graphic content. The descriptor consists of two components: feature attributes and shape metadata. The feature attributes are user properties 324 which list tabular field names and values. Reasonable attempt may be made to preserve attribute values in their original format, but it is not strictly necessary as the actual field data types are described for the layer elsewhere (see FIG. 3). In an alternative embodiment, attributes may be given purely as strings if, for example, the data types available in PDF are otherwise inadequate.

In another embodiment of the invention, the shape metadata object 340 is in the form of an Adobe Extensible Metadata Platform (XMP) stream. The XML content of the stream contains a precise description of the geometry of the original map feature. Point descriptors depict a single coordinate, polyline descriptors depict one or more paths, and polygon descriptors depict one or more closed paths (rings). A path may consist of one or more connected line segments or curves. Other geometries which should be supported by the XML schema include annotations, dimensions, multipoints, and other types supported by ESRI ArcGIS. In an alternative embodiment, the information may be stored as optional PDF content streamed following a coordinate transformation matrix (CTM) that transforms it to page coordinates.

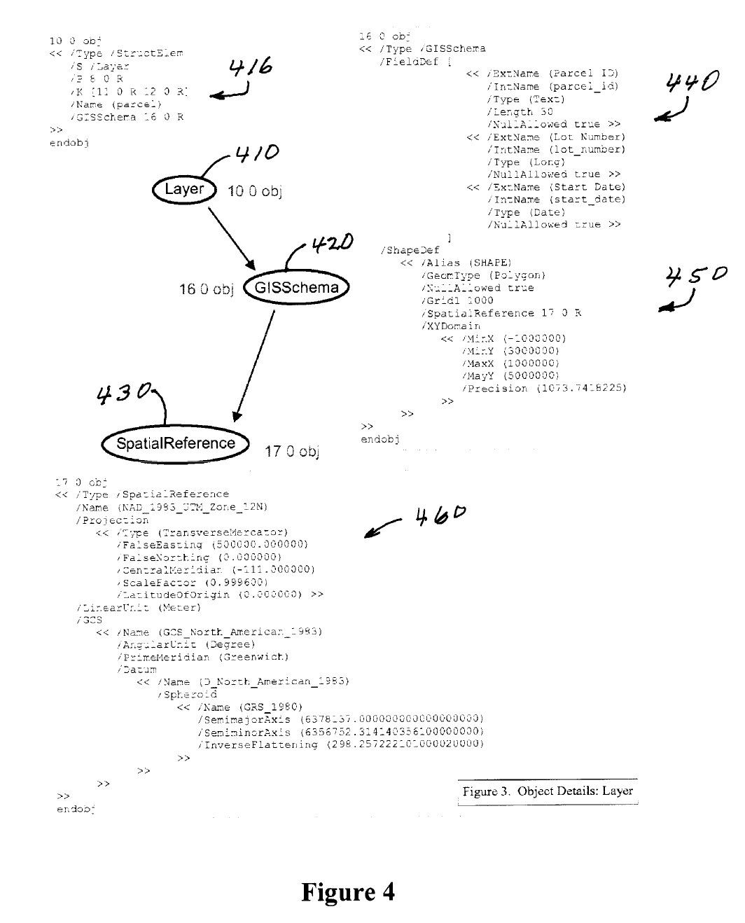

FIG. 4 diagrams how the GISSchema definition of a layer can fully define tabular attributes and geometry. Again, this allows the PDF file to act as a complete GIS data interchange medium. Note the children (K) array 416 of the Layer object 410, which refers to the two Feature objects, depicted as 234, 236 in FIG. 2. Note also that the GISSchema 420 does not necessarily need to refer to the same SpatialReference 430 as the MapBounds depicted as 222 in FIG. 2; thus data can be embedded using one coordinate system and the map itself using another.

The schema of a feature layer is documented by the GISSchema object 420. This consists of two components: the tabular field definition 440 and the shape definition 450. The tabular field definition 440 is a list of field descriptors giving name and data type information. The shape definition 450 describes the geometry (shape) field of the feature layer, including name, geometry type, and spatial reference. The spatial reference entry 460 refers to a SpatialReference object 430, which contains the details of the coordinate system used by the map layer.

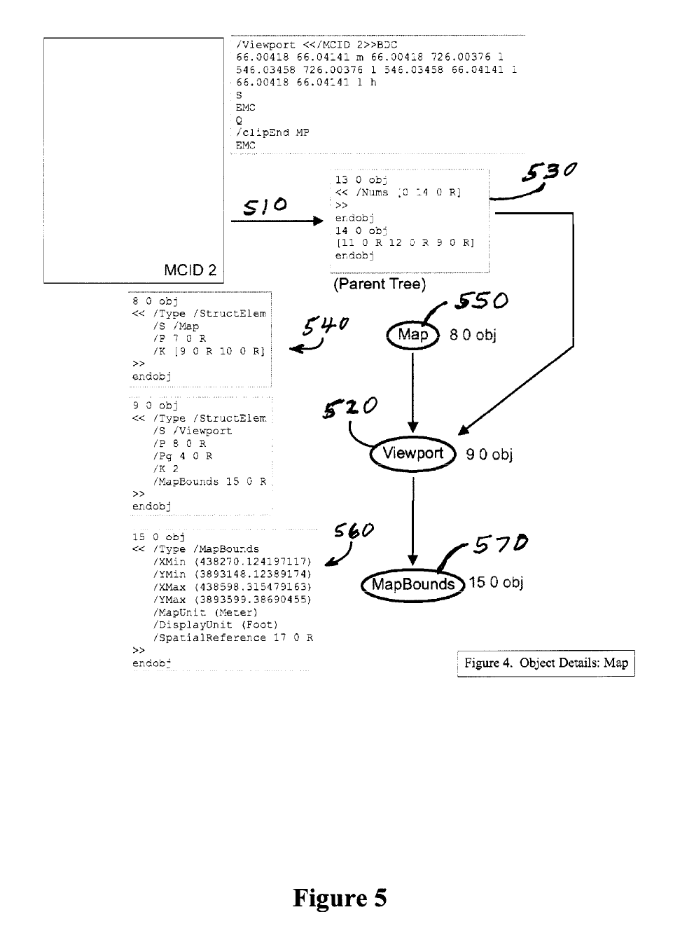

FIG. 5 diagrams how the marked content 510 representing a map boundary is linked to a Viewport object 520 via a parent tree 530. The page coordinates of the content are made available to the Software Development Kit (“SDK”), and this allows a plug-in to display coordinates and measurements in the map coordinate system without embedding JavaScript in the PDF file. Because the SpatialReference is defined, a plug-in can also convert the coordinates to other systems. Note that the children array 540 of the Map object 550 refers to both the Viewport and Layer objects. The Viewport object 520 links the graphic boundary of the map with the MapBounds 560, which is a description of the equivalent area in map coordinates. The MapBounds object 570 contains the map coordinate extents, the map units, the display units (for default measuring), and the spatial reference.

In another alternative embodiment of the present invention, using the methodology discussed above, multiple shape files will be embedded into PDF files so that they can be viewed as Transparency Groups within PDF viewing tools. Technically, a transparency group is defined as a consecutive set of objects in a transparency stack that are collected together to form a single color shape and opacity at each point. These multiple page objects can be grouped as nested objects or as a tree-structured group hierarchy. The shape file layers are embedded transparent shape file page objects such that what originated as embedded map frames, in the form of multi-coordinate system shape file maps, are now represented as stacked transparent shape file page objects defined by polyline borders.

The PDF file format specification gives specific rules for the layering sequence of layers added to the PDF. The shape file layers or data types shall be stacked with the smallest shape file map data frame at the top. This will ensure when the end-user clicks within the smallest area of the map frame that those coordinates are not hidden behind a larger shape layer area. Attribute data stored on shape file layers will be overlaid, or stacked, on top of PDF image layers. These layers are accessed through the Layers tab of Adobe Acrobat or Adobe Reader. The Adobe Acrobat or Adobe Reader API will optimize for the proper display of the shape coordinate system.

Since shape files can be transparent vector data, all the images in the PDF map are still visible when layering shape files. Currently, the GIS application ArcGIS from ESRI allows for exporting the graphic images of layered maps to the PDF application Adobe Illustrator. Adobe Illustrator can then save this layered data to PDF. As may be appreciated by one skilled in the art, subsequent version of the GIS application ArcGIS will allow for directly exporting multiple shape files to a layered PDF file structure.

The Adobe Acrobat or Adobe Reader API will allow display of shape file coordinates within an already created layered PDF file. The end-user experience will allow for anyone with a PDF viewing tool to click on a location within the PDF file, and the API will return all coordinates (lat-long, northing-easting, military grid reference system, etc.) associated with that point in the shape file. Hence, multiple coordinate systems can be associated with multiple map frames embedded as transparent shape layers within the PDF file.

In another alternative embodiment of the present invention, the native shape file data may be viewed within the PDF application. Since PDF allows for layering pages on top of each other, the bounding box of the shape file overlays the PDF image of the same map area, and all that is needed to display the coordinates for any given point in the shape file is an API that can read native shape file coordinates and display them within the PDF viewing tool. There are already many APIs to the various mapping applications that exist on the market today for viewing native shape file data within various mapping applications. As one skilled in the art will appreciate, this API functionality from mapping applications may be ported over to Adobe Acrobat and Adobe Reader for an API that provides the same functionality within PDF maps by interrogating the PDF shape file data structure.

Once the shape file is imported into the PDF file, the end user can then interact with shape file coordinates, and shape file attributes. The attributes associated with a shape file come in many flavors: text, vector line art, custom symbology, and database information. The GIS analyst exporting the shape file for import into the PDF file will have selection control over what attributes to place within the shape file.

In another alternative embodiment, the present invention allows the export of red-lines entered in the PDF application to other PDF applications and into Geographic Information Systems. The current implementation for handling red-lines within Adobe Acrobat allows for placing these red-lines on a separate layer knows as the PDF comments file layer. As will be appreciated by one skilled in the art, this functionality may be enhanced so that the vector red-lines and markups appear on both the Adobe Comments Layer in the PDF file, and on the shape file layer embedded as a PDF layer within the PDF file.

The advantage of storing the red-lines on both the PDF comment layer, and the shape file layer is that it turns Adobe Acrobat into a collaboration tool for both users of PDF and GIS viewing applications. For example in a workgroup setting, the team leader could export PDF red-lines for emailing to other Acrobat users that want to view PDF red-lines, and the team leader could export the shape file red-lines to GIS users that want to import and view the red-lines in GIS applications.

Red-lines placed on any shape file layer in the PDF file can be exported back out as a native shape file layers for import back into any GIS application. Currently the PDF comments file layer is not visible within the Adobe Layers tab. However, the PDF specification will allow for displaying native shape file layers as PDF layers in the layers tab. Using the standard red-line and markup tools available in Adobe Reader 7.0, and saving the PDF with Reader Enable, end-users could red-line and markup the shape file with available Adobe vector red-line tools, such as the arrow tool, polyline tool, polygon tool, cloud tool, circle tool, etc., and export the shape file layers with the associated vector red-lines and markups back into a GIS application. Since the GIS already stores the equivalent of the PDF map that was exported as an image, importing back just the shape file layers with associated red-lines is a very efficient way of allowing for end-to-end review of mapping data.

Adobe Acrobat allows for red-lines to be captured and stored on the specific shape file layers which will be listed in the Layers tab. Absent this functionality, the methodology may be implemented by exporting the shape files, along with the vector red-lines and markups stored on the Comments layer. In another alternative embodiment, the red-line vectors may be stored and exported in the main shape file header as bounding box vectors.

In another alternative embodiment, the present invention provides the ability to import shape files from Global Positioning System (GPS) applications that output shape files with weigh points and tracks and import these native shape files into PDF maps. This functionality allows users to view their GPS data overlaid on PDF image maps using API's to read the native shape files. This embodiment uses the same functionality described above of embedding the native shape file format elements into PDF file objects, file structure and document elements. The GPS

PDF applications, such as Adobe Acrobat, come with very robust built in tools for managing the relationship between PDF files and dBASE information. In another alternative embodiment of the present invention, this functionality is used to manage the coordinate array and dBASE information within the shape file construct. The trailer of the PDF includes a dictionary or array for pointing to elements within the Body. The shape file data and/or dBASE information can also be placed here. Depending on customer implementation requirements, as may be appreciated by those skilled in the art, there are various ways to embed the dBASE data associated with a shape file either internally or externally to the PDF file, and within different PDF specification data definitions.

Shape file information contains both coordinate information as well as information that describe the points, polylines or polygon object in the shape file layer. This information can be stored in the PDF map as described above, or it can be linked to externally via Adobe Acrobat API's that interact with data embedded into the PDF. The dBASE data can then be displayed via API's in a variety ways as are known to those skilled in the art.

In another alternative embodiment of the present invention, the methodologies described herein can apply to both 2D stream data, as well as 3D stream data, depending on whether the shape file source is 2D or 3D. The handling of 3D stream data is covered in detail for the U3D functionality of the PDF Specification (section 9.5). The methodology described herein for 2D shape files will work similarly well for presenting 3D shape file descriptions. As may be anticipated by one skilled in the art, U3D, an open file format specification, will naturally develop to allow for native viewing of 3D shape files. The greatest limitation of U3D today is that it does not provide a good data interchange with other existing 3D file formats on the market. In another alternative embodiment, the invention will allow data interchange between U3D and Shape for the publishing of 3D PDF maps to the general public. As may be anticipated by those skilled in the art, PDF applications such as Adobe will integrate the Flash and PDF and U3D functionality. In another alternative embodiment of the present invention will allow 3D animated vector graphics running inside a PDF map. Shape file vectors will be the content that the flash technology animates within the PDF, and the shape file coordinate system can be used to spatially associate and correlate all the data within the 3D PDF map.

In another alternative embodiment, the invention provides a method to embed the shape file layer in electronic graphics files of multimedia applications to provide geo-referenced video. Table 9.19, Chapter 9 of the PDF file specification goes into detail on how floating windows, for multimedia applications, can be arranged to overlay on top of existing PDF files. Hence, another useful application of the invention would be to overlay the shape file layer running inside a multimedia application so that video files or even geo-referenced video could be associated with a shape layer coordinate system running inside a PDF file with corresponding floating windows reflecting the same geographic coverage area. As will be appreciated by one skilled in the art, multimedia applications run electronic graphic files as articulated above.

In another alternative embodiment of the present invention, text that originates from embedded shape file data can be subsequently accessed and printed, or painted, over other PDF image maps as glyphs. A glyph is a specific graphical rendering of character. A font defines glyphs for a particular character set. A content stream paints glyphs on the page by specifying a font dictionary and a string object that is interpreted as a sequence of one or more character codes identifying glyphs in the font. This operation is called showing the text string. The text strings drawn in this way are called show strings, and are defined herein as character data strings. The glyph description consists of a sequence of graphics operators that produce the specific shape for that character in this font. To render a glyph, the application executes the glyph description.

A PDF content stream paints, or renders, glyphs on a page by specifying a font dictionary and a string object. Using the methodologies described herein, painting text strings that originated as shape file text strings is possible. The methodology of the invention will provide a valuable source for placing text on PDF images since the text positioning operator in the PDF specification allows for both scaling of text size and for establishing the text position in a coordinate system within the PDF.

In another alternative embodiment of the present invention, the method provides a Graphical User Interface, (“GUI”) option for creating shape file layers by dragging and dropping native shape files into PDF viewing applications such as Adobe Acrobat. This option will create a new layer within the PDF file containing the native shape file. When importing more than one shape file, the application will again sort the layer stack so that the border/neatline of the shape files are stacked with the smallest border/neatline at the top, so as not to hide layer data below.

In another alternative embodiment, an Adobe API could display shape file coordinates whenever the Acrobat Zoom tool is selected and placed over the shape file layer. Since zooming into a mapping area to view objects in the map is such a common practice, the “Cross-hair” of the zoom tool will be used to allow for viewing the exact shape file coordinate when this tool is placed over an object in the map. This GUI description is similar to military style GIS applications for viewing coordinates. In another alternative embodiment, a shape file will be imported with GPS weigh points and tracks, such as those generated by GPS Maker application, so that the end-user could see the actual weigh points, routes and tracks overlaid on a PDF map. As may be appreciated by those skilled in the art, the invention may be practiced using API's running in other PDF applications.

While there has been shown a preferred embodiment of the present invention, those skilled in the art will appreciate that certain changes may be made in the forms and arrangement of the elements for a drywall bead press without departing from the underlying spirit and scope of the invention defined by the following claims.

What is claimed is:

1. A method for embedding geographic information from a digital source map into an electronic graphics file, and embedding the native coordinate data in the digital source map into the electronic graphics file, the method comprising:
receiving an electronic graphics file representing a digital source map;
receiving geographic information associated with the digital source map, the geographic information comprising a digital shape file;
embedding the digital shape file within the electronic graphics file, the digital shape file comprising native coordinate data, the native coordinate data specifying a position in the digital shape file; and
wherein the position of the native coordinate data in the digital shape file is associated with a geographic position within the electronic graphics file.

2. The method of claim 1, wherein the digital shape file comprises a page object on a layer in the electronic graphics file.

3. The method of claim 1, wherein the digital shape file comprises at least one transparent shape file.

4. The method of claim 1, wherein the digital shape file comprises a native coordinate data array embedded within the electronic graphics file.

5. The method of claim 1, wherein the digital shape file comprises at least one bounding box, the bounding box representing a map border within the digital shape file.

6. The method of claim 1, further comprising:
receiving a geographic position selection within the electronic graphics file;
retrieving the native coordinate data of the digital shape file associated with the selected geographic position; and
displaying the native coordinate data within the electronic graphics file interface.

7. The method of claim 1 further comprising:
embedding a plurality of digital shape files within the electronic graphics file; and
wherein a geographic position within the electronic graphics file is associated with a plurality of native coordinate data from the plurality of digital shape files.

8. The method of claim 7, wherein the plurality of digital shape files is embedded as a transparency stack in the electronic graphics file.

9. The method of claim 1 wherein the coordinate data of the digital shape file comprises a character data string and a coordinate data position; and
wherein the character data string is rendered (drawn) at a geographic position within the electronic graphics file associated with the coordinate data position in the digital shape file.

10. The method of claim 1, wherein the electronic graphics file comprises at least one of the following: an Adobe Acrobat® portable document file, a portable document format file, a tagged image file format (TIF) file, geo-tiff (GeoTIFF), a scalable vector graphics (SVG) file, a Bentley Digital InterPlot (DPR) file, and an extensible markup language (XML) file.

11. The method of claim 1, wherein the electronic graphics file comprises at least one of the following: a file format viewable by a viewer, a file format viewable by a file reader application program, and a file format viewable by an application program for the display of graphics files.

12. The method of claim 1, wherein the coordinate data comprises at least one of the following: a longitude, a latitude, an elevation, a terrain feature, a set of geographic coordinates, a geographic feature, a character data string, weigh points and tracks, a road, a body of water, a mountain, a place, a land mass, and geographic information.

13. The method of claim 1, wherein the digital source map comprises at least one of the following: a digital map, a GIS landbase, a GPS output, a CAD drawing, a raster-based image, a database, a data storage device, a memory, and a digital map stored in a data storage device.

14. A method for viewing embedded native geographic information within an electronic graphics file, the method comprising:
(a) receiving an electronic graphics file with geographic information, the electronic graphics file comprising:
(1) embedded native geographic information from a digital source map, wherein the embedded native geographic information is geo-registered; and
(2) the native geographic information comprising at least one digital shape file, the digital shape file comprising native coordinate data, the native coordinate data having a position in the digital shape file; and
(b) accessing the electronic graphics file with an application program adapted to display the electronic graphics file, comprising selecting a geographic position within the electronic graphics file wherein the native coordinate data in the digital shape file, associated with the geographic position within the electronic graphics file, is displayed.

15. The method of claim 14, wherein the digital shape file comprises at least one vector red-line; and
the vector red-line is displayed within the electronic graphics file.

16. A method for embedding red-line vectors into an electronic graphics file, and associating the geographic position of the red-line vector in the electronic graphics file with a position in the native geographic information, the method comprising:
receiving an electronic graphics file representing a digital source map;
receiving native geographic information associated with the digital source map,
receiving a red-line vector in the electronic graphics file, the red-line vector having a geographic position in the electronic graphics file; and
embedding the red-line vector into the native geographic information, the embedded vector red-line having a position in the native geographic information associated with the geographic position in the electronic graphics file.

17. The method of claim 16, wherein the red-line vector comprises at least one of the following: text, graphics, points, polylines, polygons, and spheres.

18. The method of claim 16, wherein the native geographic information comprises a comments layer embedded within the electronic graphics file; and
embedding the red-line vector into the native geographic information comprises embedding the red-line vector into the comments layer.

19. The method of claim 16, wherein the native geographic information comprises a digital shape file embedded within the electronic graphics file; and
embedding the red-line vector into the native geographic information comprises embedding the red-line vector in the digital shape file.

20. The method of claim 16 further comprising a method of exporting the red-line vectors from the electronic graphics file and into a digital source map, the method comprising:
exporting a digital shape file from the electronic graphics file, the digital shape file comprised of a vector red-line, the vector maintaining a position in the digital shape file;
importing the digital shape file, with the embedded vector red-line, into a digital source map; and
wherein the position of the vector red-line in the digital source map is associated with a geographic position within the electronic graphics file.
